(19) United States
(12) Patent Application Publication
(10) Pub. No.: US 2002/0181546 A1
(43) Pub. Date: Dec. 5, 2002

(54) Preamble channels

(76) Inventors: Joseph P. Odenwalder, Rancho Santa Fe, CA (US); Sandip Sarkar, San Diego, CA (US); Stein Lundby, Solana Beach, CA (US)

Correspondence Address: Philip R. Wadsworth, Patent Department, QUALCOMM Incorporated, 5775 Morehouse Drive, San Diego, CA, 92121-1714, US

(21) Appl. No.: 09/816,562

(22) Filed: Mar. 23, 2001

(51) Int. Cl. H04B 1/69

(52) U.S. Cl. 375/130; 375/308

(57) ABSTRACT

Rather than attaching a preamble to a data payload and transmitting both on a traffic channel, multiple preamble channels are generated so that preambles are transmitted on the multiple preamble channels and data payload is transmitted on the traffic channel. Redundant subpackets carry data payload on a traffic channel, a preamble sequence is generated and is carried on a separate preamble channel, and a preamble information value is generated and is carried on another preamble channel.

### BACKGROUND

I. Field of the Invention

The present invention relates to communication systems, and more particularly, to the enhanced transmission of data packets between stations in communication systems.

II. Background

The field of wireless communications has many applications including, e.g., cordless telephones, paging, wireless local loops, personal digital assistants (PDAs), Internet telephony, and satellite communication systems. A particularly important application is cellular telephone systems for mobile subscribers. (As used herein, the term “cellular” systems encompasses both cellular and personal communications services (PCS) frequencies.) Various over-the-air interfaces have been developed for such cellular telephone systems including, e.g., frequency division multiple access (FDMA), time division multiple access (TDMA), and code division multiple access (CDMA). In connection therewith, various domestic and international standards have been established including, e.g., Advanced Mobile Phone Service (AMPS), Global System for Mobile (GSM), and Interim Standard 95 (IS-95). In particular, IS-95 and its derivatives, IS-95A, IS-95B, ANSI J-STD-008 (often referred to collectively herein as IS-95), and proposed high-data-rate systems for data, etc. are promulgated by the Telecommunication Industry Association (TIA), the International Telecommunications Union (ITU), and other well known standards bodies.

Cellular telephone systems configured in accordance with the use of the IS-95 standard employ CDMA signal processing techniques to provide highly efficient and robust cellular telephone service. Exemplary cellular telephone systems configured substantially in accordance with the use of the IS-95 standard are described in U.S. Pat. Nos. 5,103,459 and 4,901,307, which are assigned to the assignee of the present invention and fully incorporated herein by reference. An exemplary described system utilizing CDMA techniques is the cdma2000 ITU-R Radio Transmission Technology (RTT) Candidate Submission (referred to herein as cdma2000), issued by the TIA. The standard for cdma2000 is given in draft versions of IS-2000 and has been approved by the TIA. The cdma2000 proposal is backwards compatible with IS-95 systems. Another CDMA standard is the W-CDMA standard, as embodied in 3^{rd} Generation Partnership Project “3GPP”, Document Nos. 3G TS 25.211, 3G TS 25.212, 3G TS 25.213, and 3G TS 25.214.

In the CDMA systems introduced above, voice and data traffic are carried in message frames of various lengths. Typically, a remote station in the range of a base station must receive and decode a plurality of message frames in order to determine the complete voice and data payload information. Preambles are attached to the message frames to convey information as to the number of message frames that will carry a given payload. In addition to the number of frames that are needed to carry the full traffic payload, preambles can also carry information identifying the target destination of the payload and the transmission rate of the message frames. Other information, such as the radio link protocol (RLP) sequence numbers of the message frames, can also be included. Hence, the decoding of payload information is dependent upon the detection and decoding of the preambles attached to transmitted message frames. It is desirable to increase the ability of a target station to accurately detect and decode preambles, which would lead to more accurate detection and decoding of payload information.

### SUMMARY

Novel methods and apparatus for generating preambles are presented. In one aspect, a method for transmitting voice and data traffic in a wireless communication system is presented, the method comprising: generating a first preamble channel, wherein the first preamble channel carries information as to a preamble length; generating a second preamble channel, wherein the second preamble channel carries a plurality of preamble packets and the length of each of the plurality of preamble packets is carried on the first preamble channel; and generating a traffic channel, wherein the plurality of preamble packets carried on the second preamble channel are each associated with a packet carried on the traffic channel.

In another aspect, a method for generating a preamble that is not concatenated to a data subpacket on a traffic channel, the method comprising: generating a preamble for transmission on a first non-traffic channel; and generating a preamble length value for transmission on a second non-traffic channel, wherein the preamble length value is associated with the preamble transmitted on the first non-traffic channel.

In another aspect, an apparatus for generating a preamble information channel within a wireless communication system is presented, wherein the preamble information channel informs a target station of a length of a preamble transmitted on a separate channel, the apparatus comprising: a block encoder configured to receive a symbol and to output a plurality of symbols; a repetition element configured to receive the plurality of symbols from the block encoder and to output a sequence, wherein the sequence comprise a repeated pattern of the plurality of symbols; a modulation element configured to receive the sequence and to output an in-phase component and a quadrature component; and a Walsh covering element for spreading the in-phase component and the quadrature component.

In another aspect, an apparatus for generating a preamble information channel within a wireless communication system is presented, wherein the preamble information channel informs a target station of a length of a preamble transmitted on a separate channel, the apparatus comprising: a mapping element configured to receive one bit and to output +1, −1, or 0 accordingly; a repetition element configured to repeat the output of the mapping element to form a sequence; and a Walsh covering element for spreading the sequence.

In another aspect, an apparatus is presented for generating a preamble for transmission on a channel that does not carry traffic, the apparatus comprising: a convolutional encoder configured to convolve a preamble sequence; a repetition element configured to receive the convolved preamble sequence and to output a repeated sequence; a modulation element configured to modulate the repeated sequence; and a Walsh covering element for spreading the modulated sequence.

In another aspect, an apparatus is presented for transmitting voice and data payloads in a wireless communication system, comprising: means for generating a first preamble channel, wherein the first preamble channel carries information as to a preamble length; means for generating a second preamble channel, wherein the second preamble channel carries a plurality of preamble packets and the length of each of the plurality of preamble packets is carried on the first preamble channel; and means for generating a traffic channel, wherein the plurality of preamble packets carried on the second preamble channel are each associated with a packet carried on the traffic channel.

In another aspect, an apparatus is presented for transmitting voice and data payloads in a wireless communication system, the apparatus comprising: a memory element; a processing element coupled to the memory element and configured to execute an instruction set stored in the memory element, the instructions for: generating a preamble for transmission on a first non-traffic channel; and generating a preamble length value for transmission on a second non-traffic channel, wherein the preamble length value is associated with the preamble transmitted on the first non-traffic channel.

### DETAILED DESCRIPTION OF THE DRAWINGS

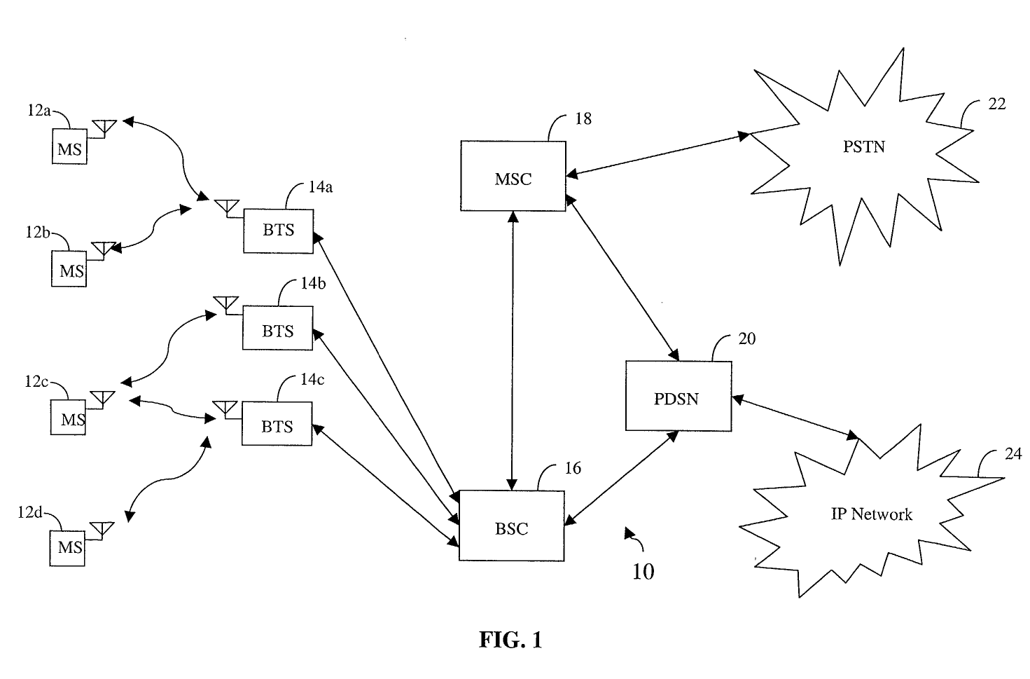

FIG. 1 is a diagram of an exemplary communication system.

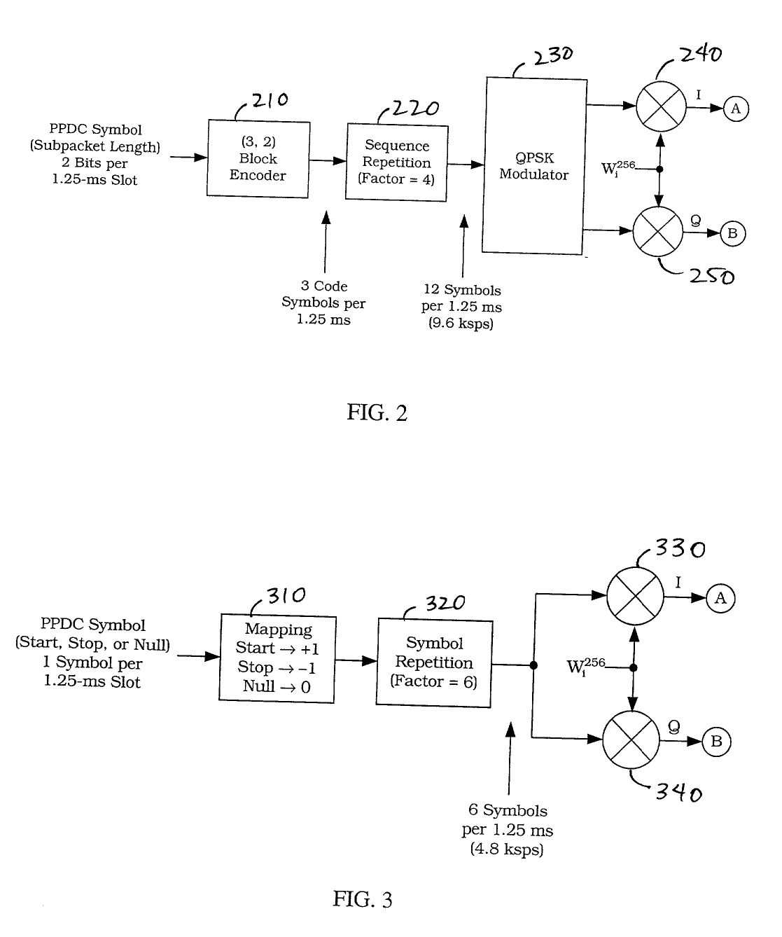

FIG. 2 is a block diagram of a F-PPDCCH structure.

FIG. 3 is a block diagram of another F-PPDCCH structure.

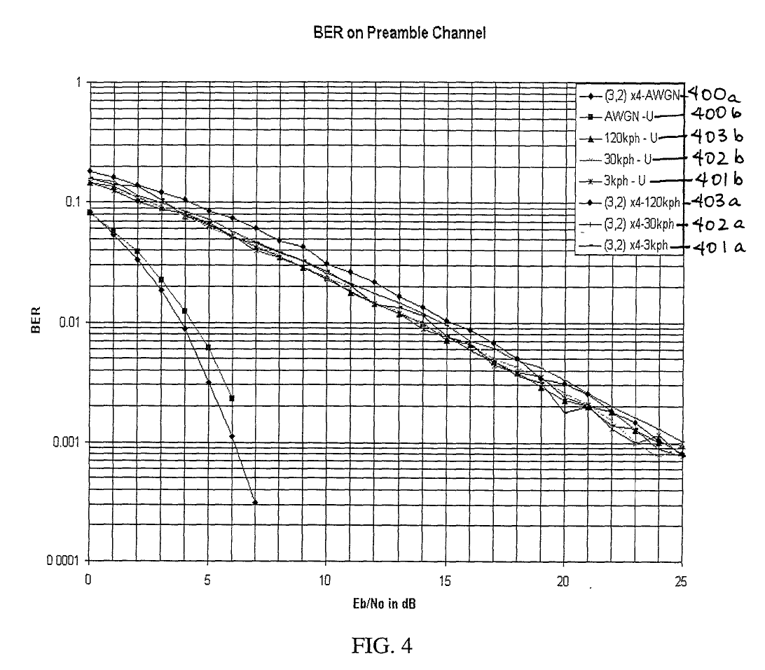

FIG. 4 is a graph comparing the performance of the two F-PPDCCH channel structures.

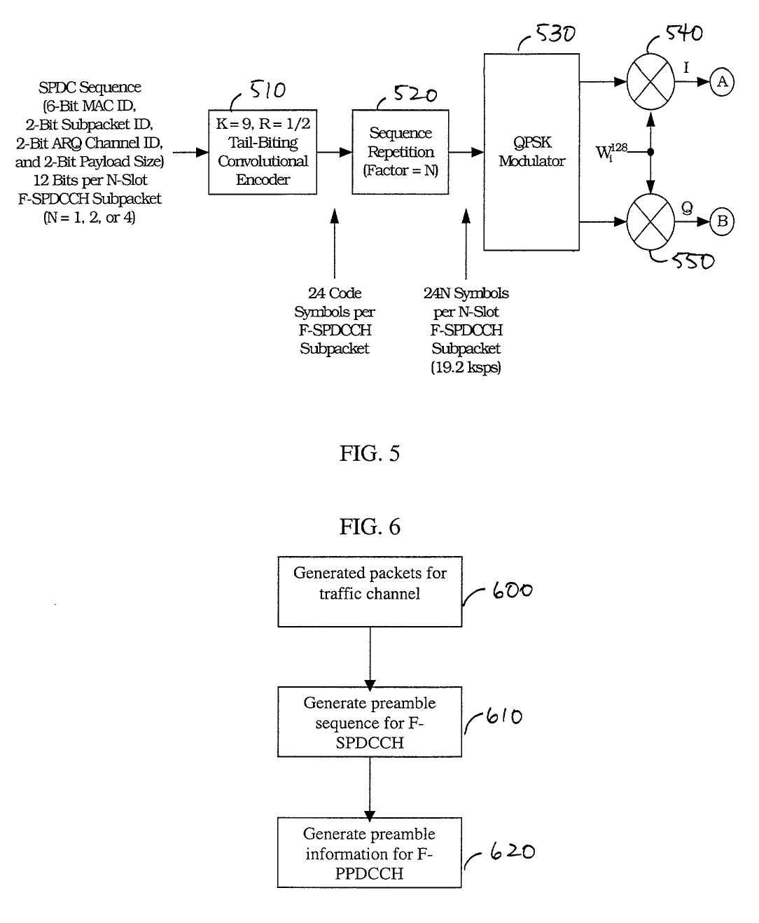

FIG. 5 is a block diagram of a F-SPDCCH structure.

FIG. 6 is a flow chart illustrating the use of multiple preamble channels.

### DETAILED DESCRIPTION OF THE EMBODIMENTS

As illustrated in FIG. 1, a wireless communication network 10 generally includes a plurality of remote stations (also called mobile stations or subscriber units or user equipment) 12a-12d, a plurality of base stations (also called base station transceivers (BTSs) or Node B) 14a-14c, a base station controller (BSC) (also called radio network controller or packet control function 16), a mobile switching center (MSC) or switch 24, a packet data serving node (PDSN) or internetworking function (IWF) 20, a public switched telephone network (PSTN) 22 (typically a telephone company), and an Internet Protocol (IP) network 18 (typically the Internet). For purposes of simplicity, four remote stations 12a-12d, three base stations 14a-14c, one BSC 16, one MSC 18, and one PDSN 20 are shown. It would be understood by those skilled in the art that there could be any number of remote stations 12, base stations 14, BSCs 16, MSCs 18, and PDSNs 20.

In one embodiment the wireless communication network 10 is a packet data services network. The remote stations 12a-12d may be any of a number of different types of wireless communication device such as a portable phone, a cellular telephone that is connected to a laptop computer running IP-based, Web-browser applications, a cellular telephone with associated hands-free car kits, a personal data assistant (PDA) running IP-based, Web-browser applications, a wireless communication module incorporated into a portable computer, or a fixed location communication module such as might be found in a wireless local loop or meter reading system. In the most general embodiment, remote stations may be any type of communication unit.

The remote stations 12a-12d may be configured to perform one or more wireless packet data protocols such as described in, for example, the EIA/TIA/IS-707 standard. In a particular embodiment, the remote stations 12a-12d generate IP packets destined for the IP network 24 and encapsulate the IP packets into frames using a point-to-point protocol (PPP).

In one embodiment, the IP network 24 is coupled to the PDSN 20, the PDSN 20 is coupled to the MSC 18, the MSC 18 is coupled to the BSC 16 and the PSTN 22, and the BSC 16 is coupled to the base stations 14a-14c via wirelines configured for transmission of voice and/or data packets in accordance with any of several known protocols including, e.g., E1, T1, Asynchronous Transfer Mode (ATM), IP, Frame Relay, HDSL, ADSL, or xDSL. In an alternate embodiment, the BSC 16 is coupled directly to the PDSN 20, and the MSC 18 is not coupled to the PDSN 20. In another embodiment, the remote stations 12a-12d communicate with the base stations 14a-14c over an RF interface defined in the 3^{rd} Generation Partnership Project 2 “3GPP2”, “Physical Layer Standard for cdma2000 Spread Spectrum Systems,” 3GPP2 Document No. C.P0002-A, TIA PN-4694, to be published as TIA/EIA/IS-2000-2-A, (Draft, edit version 30) (Nov. 19, 1999), which is fully incorporated herein by reference.

During typical operation of the wireless communication network 10, the base stations 14a-14c receive and demodulate sets of reverse-link signals from various remote stations 12a-12d engaged in telephone calls, Web browsing, or other data communications. Each reverse-link signal received by a given base station 14a-14c is processed within that base station 14a-14c. Each base station 14a-14c may communicate with a plurality of remote stations 12a-12d by modulating and transmitting sets of forward-link signals to the remote stations 12a-12d. For example, as shown in FIG. 1, the base station 14a communicates with first and second remote stations 12a, 12b simultaneously, and the base station 14c communicates with third and fourth remote stations 12c, 12d simultaneously. The resulting packets are forwarded to the BSC 16, which provides call resource allocation and mobility management functionality including the orchestration of soft handoffs of a call for a particular remote station 12a-12d from one base station 14a-14c to another base station 14a-14c. For example, a remote station 12c is communicating with two base stations 14b, 14c simultaneously. Eventually, when the remote station 12c moves far enough away from one of the base stations 14c, the call will be handed off to the other base station 14b.

If the transmission is a conventional telephone call, the BSC 16 will route the received data to the MSC 18, which provides additional routing services for interface with the PSTN 22. If the transmission is a packet-based transmission, such as a data call destined for the IP network 24, the MSC 18 will route the data packets to the PDSN 20, which will send the packets to the IP network 24. Alternatively, the BSC 16 will route the packets directly to the PDSN 20, which sends the packets to the IP network 24.

In CDMA systems, multiple channels are used in the forward and reverse links to transmit signals between stations. These channels are generically referred to herein as pilot channels, synchronization channels, access channels, broadcast channels, paging channels, dedicated control channels, supplemental channels, and traffic channels. The process of transmitting both data and voice on the traffic channels can be problematic. In a system using variable rate encoding and decoding of voice traffic, a base station will not transmit voice traffic at a constant power level. The use of variable rate encoding and decoding converts speech characteristics into voice frames that are optimally encoded at variable rates. In an exemplary CDMA system, these rates are full rate, half rate, quarter rate, and eighth rate. These encoded voice frames can then be transmitted at different power levels, which will achieve a desired target frame error rate (FER) if the system is designed correctly. For example, if the data rate is less than the maximum data rate capacity of the system, data bits can be packed into a frame redundantly. If such redundant packing occurs, power consumption and interference to other remote stations may be reduced because the process of soft combining at the receiver allows the recovery of corrupted bits. The use of variable rate encoding and decoding is described in detail in U.S. Pat. No. 5,414,796, entitled “VARIABLE RATE VOCODER,” assigned to the assignee of the present invention and incorporated by reference herein. Since the transmission of voice traffic frames does not necessarily utilize the maximum power levels at which the base station may transmit, packetized data traffic can be transmitted using the residual power.

Hence, if a voice frame is transmitted at a given instant x(t) at X dB but the base station has a maximum transmission capacity of Y dB, then there is (Y−X) dB residual power that can be used to transmit data traffic. Since the voice traffic frames are transmitted at different transmission power levels, the quantity (Y−X) db is unpredictable. One method for dealing with this uncertainty is to repackage data traffic payloads into repetitious and redundant subpackets.

For illustrative purposes only, the nomenclature of the cdma2000 system is used herein. Such use is not intended to limit the implementation of the invention to cdma2000 systems. In an exemplary CDMA system, data traffic can be transported in packets, which are composed of subpackets, which occupy slots. Slot sizes have been designated as 1.25 ms, but it should be understood that slot sizes may vary in the embodiments described herein without affecting the scope of the embodiments.

Through the process of soft combining, wherein one corrupted subpacket is combined with another corrupted subpacket, the transmission of repetitious and redundant subpackets can allow a system to transmit data at a minimum transmission rate. The transmission of repetitious and redundant subpackets is desirable in the presence of fading. Rayleigh fading, also known as multipath interference, occurs when multiple copies of the same signal arrive at the receiver in destructive manner. Substantial multipath interference can occur to produce flat fading of the entire frequency bandwidth. If the remote station is traveling in a rapidly changing environment, deep fades could occur at times when subpackets are scheduled for retransmission. When such a circumstance occurs, the base station requires additional transmission power to transmit the subpacket. This can be problematic if the residual power level is insufficient for retransmitting the subpacket.

For example, if a scheduler unit within a base station receives data payload for transmission to a remote station, the data payload is redundantly packed into a plurality of subpackets, which are sequentially transmitted to a remote station. Redundancy refers to the substantially similar data payload carried by each subpacket. When transmitting the subpackets, the scheduler may decide to transmit the subpackets either periodically or in a channel sensitive manner.

Since the remote station has no way of determining when a subpacket addressed to itself will arrive, a preamble must be attached to each subpacket, with the addressing information for the remote station. If the subpacket transmissions are periodic, then the first subpacket, at the least, must have an easily detectable and decodable preamble, which will also inform the receiving station of the interval at which future subpacket transmissions will arrive. Alternatively, the delay between periodic transmissions may be a system parameter that is already known to the receiver. If the subsequent subpacket transmissions after the first subpacket transmission are aperiodic, then each subsequent subpacket transmission must have a preamble.

In an exemplary cdma2000 system, an ARQ channel is included in the reverse link, so that a remote station can transmit an acknowledgment signal if a subpacket has been correctly decoded. If a base station receives such a signal, then the redundant subpackets can be discarded, rather than transmitted. In addition, a supplemental channel is dedicated for aperiodic transmissions such the ones described above.

In this method, the remote stations must be able to detect and decode the redundant subpackets. Since the additional subpackets carry redundant data payload bits, the transmission of these additional subpackets will be referred to alternatively as “retransmissions.” In order to detect the retransmissions, it is necessary for the remote station to be able to detect the preamble bits that precede the subpackets.

It should be noted that if the retransmission is being transmitted at a lower available power, then the preamble would also be transmitted at a lower available power. Since the accurate decoding of the preamble is vital, there is a possibility that the entire subpacket will be lost if the receiving party cannot successfully decode the preamble at the lower residual power.

Another consideration is the overhead occupied by the preamble. If the length of a preamble is M bits and the length of the subpacket is N bits, then a constant percentage M/N of the transmitted bitstream is devoted to non-traffic information. This inefficiency implies that a more optimal data transmission rate can be achieved if preamble information can be more efficiently conveyed.

The embodiments described herein are for generating and using preambles so that the data and voice payload on the traffic channels are more easily detectable and the amount of payload bits on the traffic channel is maximal.

In one embodiment, two separate, dedicated, non-traffic channels are created to carry preamble information. A first channel, herein referred to as a Forward Primary Packet Data Control Channel (F-PPDCCH), is used to convey information as to the sub-packet lengths of preambles on a second channel. The second channel, herein referred to as a Forward Secondary Packet Data Control Channel (F-SPDCCH), is used to carry preambles of varying length. The preambles on the F-SPDCCH are used to decode the voice and data payload on a separate traffic channel. Hence, three separate channels are needed to carry traffic information on the forward link.

These three separate channels are used in order to minimize the impact of varying transmission power levels. As discussed above, varying transmission power levels will be used to convey data packets to remote stations operating within the range of a base station. In accordance with optimality algorithms in the scheduling element of the base station, if message frames are to be transmitted at a high transmission power level, then fewer slots are assigned to carry the message frames. At high transmission power levels, fewer slots are needed in order to achieve a low frame error rate (FER). Correspondingly, preamble sizes can also be adjusted in response to transmission power levels.

In one embodiment, preambles are generated to occupy predetermined numbers of slots. For example, a preamble sequence can be generated to occupy 1, 2, 4, or 8 slots. In a cdma2000 system, slot sizes are 1.25 ms in duration. In a CDMA High Data Rate (HDR) system, slot sizes are 1.66 ms in duration. It should be noted that the actual size of the slots or the actual range of slot numbers could be varied without affecting the scope of this embodiment.

In one embodiment, a two-bit symbol can be used to indicate the number of F-SPDCCH slots that are occupied by a preamble. FIG. 2 is a block diagram of an apparatus that will generate symbols on an F-PPDCCH channel based on a two-bit input. A two-bit symbol that is associated with a 1.25 ms slot enters a block encoder 210. The two bits indicate the length of an associated preamble on the F-SPDCCH channel. The block encoder 210 is configured to output three code symbols for each two-bit input, wherein the three code symbols are associated with the same 1.25 ms slot. A repetition element 220 receives the three code symbols and generates a sequence that is composed of sequence repetitions of the three code symbols. For this embodiment, an optimal repetition factor is four (4), so that there are twelve (12) symbols now associated with the 1.25 ms slot, at a rate of 9.6 ksps. The result is modulated by a quadrature phase shift keying (QPSK) modulator 230 onto multilevel values that represent four phases. The resulting in-phase and quadrature sequences of modulation symbols are spread by an i^{th} 256-ary Walsh code function by multipliers 240, 250. The use of Walsh codes provides for channelization and for resistance to phase errors in the receiver. It should be noted that for other CDMA systems, other orthogonal or quasi-orthogonal functions could be substituted for Walsh code functions.

Table 1 provides the mapping from block-encoded symbols to the number of slots in F-SPDCCH. For illustrative purposes, a simple parity check code is implemented in the block encoder 210 of this example.

TABLE 1
F-PPDCCH (3,2) Simplex Code

| Number of F-SPDCCH slots | Coded Symbols |
|---|---|
| 1 | 000 |
| 2 | 101 |
| 4 | 110 |
| 8 | 011 |

In another embodiment, a one-bit approach can be used to indicate the number of F-SPDCCH slots that are occupied by a preamble message. Bits “0” and “1” and NULL (representing the lack of any transmission) are used to indicate the lengths of the preambles on F-SPDCCH. Hence, the modulation is effectively binary phase shift keying (BPSK) instead of the QPSK modulation in the previous embodiment. FIG. 3 is a block diagram of an apparatus that will generate the F-PPDCCH channel of this embodiment. The symbol (0, 1, or NULL) is input into a mapping element 310, wherein the symbol is mapped to +1, −1, or 0. The resultant value is repeated in repetition element 320. An exemplary repetition factor is six (6) so that the rate is 4.8 ksps. The six symbols are then spread by the j^{th} 256-ary orthogonal Walsh code function by multipliers 330, 340, into in-phase and quadrature phase components. It should be noted that for other CDMA systems, other orthogonal or quasi-orthogonal functions could be substituted for Walsh code functions.

Since NULL and non-NULL transmissions are being made, energy detection must be performed by a receiver in order to distinguish between the NULL and non-NULL transmissions. Methods for detecting energy transmissions are well known in the art and will not be described herein. Once the energy detection is performed, demodulation and decoding of the channel can be performed. Alternatively, hypothesis testing can be performed to determine soft metrics that are provided to a decoder. One method of encoding F-PPDCCH information is shown in Table 2.

TABLE 2
F-PPDCCH Input Symbol Sequences with 1-bit Approach

| | | F-PPDCCH |
|---|---|---|
| Number of Slots | Number of Slots | Symbol Sequence |
| per F-PDCH | per F-SPDCCH | (After Bit Mapping) |
| 1 | 1 | −1 |
| 2 | 2 | +1, −1 |
| 4 | 4 | +1, 0, 0, −1 |
| 8 | 4 | +1, 0, −1, 0, 0, 0, 0, 0 |

In this embodiment, the number of slots in each channel substantially coincides, so that the number of slots occupied by a preamble coincides with the number of slots occupied by the data traffic, except where data traffic occupies eight (8) slots.

FIG. 4 is a graph illustrating the performance of the two embodiments described above. The signal to noise ratio per bit (Eb/No) in dB is plotted against the bit error rate (BER) of the preamble. Performance-wise, the two embodiments track each other closely, as shown by the lines representing 0 kph, 3 kph, 30 kph, and 120 kph 400a, 400b, 401a, 401b, 402a, 402b, 403a, 403b.

Preamble sequences that are carried by the F-SPDCCH can be generated in accordance with FIG. 5. In an embodiment that could accommodate a cdma2000 system, twelve (12) bits per N-slot can be designated to carry a 6-bit medium access layer (MAC) identification value, a 2-bit subpacket identification value, a 2-bit ARQ channel identification value, and a 2-bit payload size value, wherein N equals 1, 2, or 4. The 12 bits are input into a tail-biting convolutional encoder 510, wherein the constraint length K equals 9, and the rate is ½. Hence, twenty-four (24) code symbols are generated for input into a repetition element 520, which generates a sequence with a repetition factor of N. The 24N symbols per N-slot F-SPDCCH subpacket modulated by a QPSK modulation element 530, and the resulting in-phase and quadrature phase symbols are then spread by multiplier 540, 550 using the i^{th} 128-ary Walsh code function. It should be noted that for other CDMA systems, other orthogonal or quasi-orthogonal functions could be substituted for Walsh code functions.

Replacing a block encoder, a tail-biting convolutional encoder is used instead, wherein the shift register is initialized with the last 8 bits of a previous 12-bit sequence, rather than zeros. In order to decode a signal generated by the structure of FIG. 5, the decoder would first combine the repeated symbols to determine twenty-four (24) soft decision values. This combined sequence is then repeated to arrive at eight (8) sequences. This sequence of 24×8 soft decisions is then input into a normal, tail-off K=9, R=½ decoder, which returns a sequence of 12×8 decoded bits. The fifth sequence of the twelve (12) bits is then chosen as the output of the decoding.

The repeated, tail-biting, K=9, R=½ code results in a code with a favorable weight distribution. In this instance, the term “weight” indicates the number of “1”s in a codeword. For this particular code, the weight distribution is shown below in Table 3.

TABLE 3
Weight Distribution of the Tail Biting Code

| Weight | Number of Codewords |
|---|---|
| 0 | 1 |
| 8 | 759 |
| 12 | 2576 |
| 16 | 759 |
| 24 | 1 |

As detailed in Table 3, all of the codewords have a minimum distance (dₘᵢₙ) of at least 8. Codewords with this property are highly resilient to errors.

Since the preamble information and the preamble sequences are transmitted on channels that are separate from the traffic channels, it is possible to adjust the transmission power levels of the non-traffic channels in accordance with desired system constraints. For example, the FER of the traffic channel can be increased from 1% if the availability of transmission power is limited, but the FER on the preamble channels can remain at 1% or lower.

Various methods exist that allows a receiving station to associate a received preamble with a received data subpacket. In one embodiment, preambles and data subpackets are transmitted in slots that are aligned between channels. For example, a preamble length value arriving in the n^{th} slot of the F-PPDCCH channel will be associated with the preamble arriving in the n^{th} slot of the F-SPDCCH channel, which would be associated with the data subpacket arriving in the n^{th} slot of the traffic channel. Alternatively, system parameters may be set up to associate the preamble arriving in the n^{th} slot with the data subpacket arriving in the m^{th} slot of the traffic channel.

FIG. 6 is a flow chart summarizing the embodiments described above. At step 600, a control processor supervises the generation of a plurality of data subpackets for transmission on a traffic channel. At step 610, the control processor supervises the generation of a plurality of preamble subpackets for transmission on a separate channel, wherein each of the plurality of preamble subpackets is associated with each of the plurality of data subpackets. The information that is carried within the plurality of preamble subpackets is supplied by a scheduling element in a base station, which determines the rates and the slots that will be used to transmit the plurality of data subpackets. At step 620, the control processor commands the generation of a plurality of preamble information symbols for transmission on another separate channel, wherein each of the plurality of preamble information symbols is associated with each of the plurality of preamble subpackets, and each of the plurality of preamble information symbols convey a length value for the associated preamble subpacket.

Thus, novel and improved methods and apparatus for generating preambles have been described. Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for transmitting voice and data traffic in a wireless communication system, comprising:
generating a first preamble channel, wherein the first preamble channel carries information as to a preamble length;
generating a second preamble channel, wherein the second preamble channel carries a plurality of preamble packets and the length of each of the plurality of preamble packets is carried on the first preamble channel; and
generating a traffic channel, wherein the plurality of preamble packets carried on the second preamble channel are each associated with a packet carried on the traffic channel.

2. The method of claim 1, wherein the information as to the preamble length is carried by a two-bit payload.

3. The method of claim 1, wherein the information as to the preamble length is carried by a one-bit payload.

4. A method for generating a preamble that is not concatenated to a data subpacket on a traffic channel, comprising:
generating a preamble for transmission on a first non-traffic channel; and
generating a preamble length value for transmission on a second non-traffic channel, wherein the preamble length value is associated with the preamble transmitted on the first non-traffic channel.

5. The method of claim 4, wherein the preamble length value is represented by two bits.

6. The method of claim 4, wherein the preamble length value is represented by one bit.

7. An apparatus for generating a preamble information channel within a wireless communication system, wherein the preamble information channel informs a target station of a length of a preamble transmitted on a separate channel, comprising:
a block encoder configured to receive a symbol and to output a plurality of symbols;
a repetition element configured to receive the plurality of symbols from the block encoder and to output a sequence, wherein the sequence comprises a repeated pattern of the plurality of symbols;
a modulation element configured to receive the sequence and to output an in-phase component and a quadrature component; and
a Walsh covering element for spreading the in-phase component and the quadrature component.

8. The apparatus of claim 7, wherein the symbol comprises two bits.

9. The apparatus of claim 8, wherein the block encoder outputs three code symbols for the two-bit symbol.

10. The apparatus of claim 7, wherein the modulation element performs quadrature phase-shift keying (QPSK) modulation.

11. The apparatus of claim 7, wherein the Walsh covering element uses a 256-ary Walsh code.

12. An apparatus for generating a preamble information channel within a wireless communication system, wherein the preamble information channel informs a target station of a length of a preamble transmitted on a separate channel, comprising:
a mapping element configured to receive one bit and to output +1, −1, or 0 accordingly;
a repetition element configured to repeat the output of the mapping element to form a sequence; and
a Walsh covering element for spreading the sequence.

13. An apparatus for generating a preamble for transmission on a channel that does not carry traffic, comprising:
a convolutional encoder configured to convolve a preamble sequence;
a repetition element configured to receive the convolved preamble sequence and to output a repeated sequence;
a modulation element configured to modulate the repeated sequence; and
a Walsh covering element for spreading the modulated sequence.

14. The apparatus of claim 13, wherein the convolutional encoder is a tail-biting convolutional encoder.

15. The apparatus of claim 13, wherein the modulation element performs quadrature phase shift-keying (QPSK) modulation.

16. The apparatus of claim 13, wherein the Walsh covering element uses a 128-ary Walsh code.

17. An apparatus for transmitting voice and data payloads in a wireless communication system, comprising:
means for generating a first preamble channel, wherein the first preamble channel carries information as to a preamble length;
means for generating a second preamble channel, wherein the second preamble channel carries a plurality of preamble packets and the length of each of the plurality of preamble packets is carried on the first preamble channel; and
means for generating a traffic channel, wherein the plurality of preamble packets carried on the second preamble channel are each associated with a packet carried on the traffic channel.

18. An apparatus for transmitting voice and data payloads in a wireless communication system, comprising:
a memory element; and
a processing element coupled to the memory element and configured to execute an instruction set stored in the memory element, the instructions for:
generating a preamble for transmission on a first non-traffic channel; and
generating a preamble length value for transmission on a second non-traffic channel, wherein the preamble length value is associated with the preamble transmitted on the first non-traffic channel.
